(19) United States
(12) Patent Application Publication
(10) Pub. No.: US 2002/0198803 A1
(43) Pub. Date: Dec. 26, 2002

(54) Method and apparatus for facilitating monetary and commercial transactions and for providing consumer reward programs

(76) Inventor: Rick Rowe, Reno, NV (US)

Correspondence Address: Weide & Miller, Ltd., 11th Floor, Suite 1130, 330 South 3rd Street, Las Vegas, NV, 89101, US

(21) Appl. No.: 10/091,381

(22) Filed: Mar. 4, 2002

Related U.S. Application Data
(63) Continuation-in-part of application No. 09/497,788, filed on Feb. 3, 2000.

(51) Int. Cl. G06F 17/60

(52) U.S. Cl. 705/35

(57) ABSTRACT

One or more methods and apparatus for facilitating monetary and commercial transactions is disclosed. One or more embodiments of the invention comprise a method of a customer establishing a financial account with an account provider, the account having features particularly useful in facilitating monetary and commercial transactions. One or more embodiments of the invention comprises one or more methods and apparatus associating a plurality of financial account reward programs with financial transactions, the financial transactions engaged in using a credit card, debit card, smart card or other financial instrument associated with the customer's cash or credit based financial account, where each of the financial transactions are grouped into a plurality of transaction categories, the categories assigned to a plurality of reward programs. Reward program information is generated from financial transactions information from financial transactions assigned to particular categories. A customer may use and manage reward information remotely.

### RELATED APPLICATIONS

This application is a continuation-in-part of U.S. application Ser. No. 09/497,788 filed Feb. 3, 2000.

### FIELD OF THE INVENTION

The present invention relates to methods and devices for permitting monetary transactions, such as the transfer of funds and the payment of monies, and commercial transactions, such as the purchase of goods, and further relates to multiple consumer reward programs associated with the grouping of financial account transactions into predefined transaction categories within a single financial account.

### BACKGROUND OF THE INVENTION

A variety of methods and devices are currently available for facilitating the purchase of goods or services and the transfer of money. Some of the devices include cash, checks and credit cards. Some of the methods include by mail or in-person payments and wire transfers. These current methods and devices have numerous limitations, some of which are evident when considering a variety of situations.

One limitation relates to the ability of minors to make purchases. In the past, minors have generally made purchases in cash or check either tendered directly to the vendor at the vendor's location or mailed to the vendor. With the advent of the Internet and telephonic phone orders, consumers are now offered the ability to purchase goods on-line or over the phone, remote from the vendor offering the goods or services. A primary advantage or purchasing goods in these manners is that the time delay associated with mailing an order to the vendor is eliminated. In either case, however, to realize these speed advantages, the customer must tender payment to the remote vendor at the time the order is placed instead of mailing payment to the vendor. As such, nearly all on-line and telephonic purchases are facilitated by use of a credit card. A user places an order and provides their credit card information, either directly to a representative of the vendor or via data input on-line. A retailer then uses the card information to receive payment from the authority issuing the credit to the user of the credit card.

Generally, minors do not have access to credit cards. One reason for this is that under the law, minors are not necessarily legally bound to their actions. Thus, a credit issuing authority which issues a card to a 17 year old may find that it can not force the minor to pay any debts incurred by using the card. In addition, parents wishing to teach their children financial responsibility often do not wish to provide cards to their children where they can not monitor and control the expenditures by the child.

ATM or “automated teller machine” cards are available which are linked to a bank account. These cards permit a user to withdraw funds from their account, such as at a cash dispensing machine. Some of these cards may also be accepted by retailers, both on the Internet and at the retailer's location. A significant problem with these cards is that they are linked to the user's primary bank account. If the user's card information is intercepted, such as during an on-line transaction, a thief may be able to completely empty the user's primary banking account of all funds. In addition, a user may not even be aware that their card has been misplaced or lost for a long period of time during which another party may find the card and access their account.

Currently, there is also no convenient means for providing gifts or promotions to consumers which is compatible both with standard retail store and on-line purchasing. For example, a gift giver may travel to a store and purchase a “gift certificate” to the store. The gift certificate comprises a paper check, magnetic striped card or similar item. The recipient of the gift may travel to the store and present the gift certificate to serve as payment for goods. Unfortunately, the recipient of the gift certificate must travel to the store to use it. In many situations, this is undesirable, such as when the gift recipient lives far from the store where it was purchased.

Another problem with gift certificates is that they are limited in their acceptance. Both those who give and receive gift certificates desire the ability to use the gift certificate at a wide variety of locations, permitting the gift recipient maximum latitude in selecting their gift. Gift certificates are sometimes available for use at a number of stores at a particular location. These gift certificates are issued by a central authority, such as a mall at which all of the stores are located. These certificates are not otherwise accepted, however.

Prior art financial accounts have been managed as all-inclusive accounts associated with a consumer. These financial accounts include credit cards, debit cards, smart cards, or other financial instrument associated with credit and cash financial accounts. Traditionally, financial accounts have provided statements of individual transactions without categorizing the accounts by expense categories such as dining, travel, clothing, etc. These accounts were not well organized according to how they were used by the consumer. The main objective of such accounts was to provide the consumer a monthly total associated with the transactions summary.

Reward programs associated with consumer financial accounts are well known in the industry. The reward program basically gives the consumer a reward for using their financial account to make purchases.

Examples of these reward programs include the Gold Delta SkyMiles® Card which gives the consumer 10,000 Skymiles with the first purchase and allows the consumer to earn 1 Skymile for every eligible dollar spent.

Other reward programs are the American Express Platinum Cash Rebate Cards which gives 2% cash back on purchases and the Visa NextCard® which earns free flights and reward points redeemable for merchandise when the card is used to make purchases.

Other reward programs for promoting the usage of financial accounts are well known. These reward programs are all generally designed to reward a financial account holder for using the financial account for preferred purchases. Such reward programs are typically either reward point accrual programs where points or miles are rewarded based upon the use of the account, tiered reward programs which qualify the account holder for rebates or rewards as the use of the account exceed predefined amounts and other customized programs.

Burton et al discloses a tiered reward program in U.S. Pat. No. 5,025,372. The '372 patent describes a system for processing and distributing rewards based on a participant's achieving a predefined level of performance. While the '372 patent provides increased flexibility and motivation for the consumer to select and receive their own personal awards, the consumer remains limited in the way a reward may be realized. With financial accounts now becoming much more sophisticated, more flexibility is possible and not envisioned by the '372 patent.

All of the aforementioned reward programs are presented to the consumer for the particular financial account they have chosen and fail to provide the consumer with the added flexibility needed as these financial accounts become more complex in managing financial transactions.

Examples of newer more complex financial account products include the Quicken MasterCard® which enables the consumer to break down their purchases into specific categories. The Quicken Business MasterCard® transactions are categorized for the consumer and allow the consumer to manage their financial account.

Further, as the consumer's access to their financial account continues to get easier with the growth of the Internet, consumers are demanding flexibility with those financial accounts. These financial account providers are just now becoming more sophisticated and are providing greater reporting information to their customers. Yet the reward programs have not changed and remain oriented toward general use of the consumer's financial account.

U.S. Pat. No. 5,806,045, Biorge, et.al., discloses a transaction system for implementing a multiple provider incentive program in an off-line or a selective on-line environment which allows multiple transactions to be processed for a large number of service and merchandise providers and producers. Incentive credits are allocated and redeemed by first conducting a transaction between a customer and a provider where a transaction amount is derived and an incentive credit total stored in the customer device such as a smart card with local storage. The physical customer device can then be checked to determine whether it has incentive credits to redeem. If incentive credits are stored on the customer device, the customer is asked whether he wishes to redeem any of the accrued incentive credits. While the '045 patent processes transactions and accumulates incentive credits onto a customer device which is later used to redeem the incentive credits, the '045 patent fails to envision the possible flexibility or reward programs with modern financial accounts.

U.S. Pat. No. 6,327,573, Walker, et.al., discloses an incentive reward system and method enabling a frequent shopper reward system which is capable of tracking performance data of a plurality of members or sub-account holders linked to a single frequent shopper account. The '573 patent also fails to envision the possible flexibility available for the individual financial account holder.

U.S. Pat. No. 6,018,718, Walker et.al., discloses a method for providing and managing a customized tiered reward offer to a holder of a financial account. The '718 patent discloses a method for providing and managing a customized reward offer to a holder of a financial account. The methods disclosed include the steps of determining a first performance target associated with the financial account and the steps of selecting a reward offer. Additional steps are disclosed where the collecting of transaction data associated with the financial account is described. The transaction data is evaluated to determine a second performance target associated with the financial account. The collected transaction data is then compared to the first performance target. If the collected transaction data exceeds the first performance target, the financial account is updated to reflect the reward. While the '718 patent establish levels and performance targets associated with rewarding the account holder for transactions, it too fails to envision the possibility of providing a plurality of reward programs and increased flexibility for use with a single financial account.

Accordingly, all of these previous reward programs, systems and methods suffer from Several disadvantages. First, the reward program assigned to a financial account is limited to a reward program structured by the financial account provider. Other disadvantages include the lack of financial account flexibility available to the consumer. Financial accounts and the flexibility available to the consumer continue to become more sophisticated making presently available financial account reward programs obsolete. The disclosed invention solves this problem by providing the consumer with a plurality of reward programs oriented towards specific financial transaction categories associated with the use of their financial account.

It is desirable to provide one or more methods and apparatus which serve to facilitate monetary and commercial transaction categorization and association with a plurality of reward programs in a flexible manner that overcomes the above-stated limitations. The disclosed invention provides more options for the consumer and greater incentives for the user of a financial account.

### SUMMARY OF THE INVENTION

The present invention comprises one or more methods and apparatus for facilitating financial transactions and reward programs.

One or more embodiments of the invention comprise a method of a customer establishing a financial account with an account provider, the account having features particularly useful in facilitating monetary and commercial transactions. This method comprises the steps of providing customer data to the account provider, establishing an account type, assigning a value limit for the account, depositing funds in the financial account in an amount not exceeding the value limit, assigning the financial account an expiration date after which access to the financial account is generally prohibited by a user, and generating an account signature for use in establishing later entitlement to access the financial account.

One or more embodiments of the invention comprise an account which is particularly useful in facilitating monetary and commercial transactions. The financial account has monetary funds associated therewith which may be debited from the account, an expiration date associated therewith after which access to the account is prevented, a maximum funds value comprising the maximum fund s which may be associated with the account, and account data for use in establishing entitlement to access the account.

One or more embodiments of the invention comprise a method of facilitating a commercial transaction comprising establishing a financial account, the account having a maximum funds limit, funds associated therewith not exceeding the limit, an expiration date after which commercial transactions are prohibited, and account access data, a customer activating the account in order to utilize the account, determining if the customer wishes to utilize the account to facilitate a commercial transaction, determining if access to the account is permitted if it is determined that the customer wishes to utilize the account, and if access is permitted, and debiting funds from the account in order to facilitate the transaction.

One or more embodiments of the invention comprise a system and method that associates a plurality of financial account reward programs with predefined transaction categories within a single financial account. The financial transactions are those made through the use of a credit card, debit card, smart card or other financial instrument associated with the cash or credit based financial account.

The financial transactions are grouped into a plurality of defined transaction categories such as travel, entertainment, and dining. Each of the plurality of transaction categories may each have its own independent reward program with each reward program defined independent of any other defined category or reward program.

The financial account can also be managed over the Internet, facilitating the redemption of rewards based upon selections made by the consumer and the updating of the consumers reward totals. It will be appreciated from the foregoing discussion that the present invention represents a significant advance in financial account reward programs and provides greater consumer financial account management flexibility.

Further objects, features, and advantages of the present invention over the prior art will become apparent from the detailed description of the drawings which follows, when considered with the attached figures.

### DESCRIPTION OF THE DRAWINGS

FIG. 1 is a flow diagram illustrating a method in accordance with the present invention;

FIG. 1(a) is a flow diagram illustrating in detail a method comprising a step of establishing an account in accordance with the method illustrated in FIG. 1;

FIG. 1(b) is a flow diagram illustrating in detail a method comprising a step of activating an account in accordance with the method illustrated in FIG. 1;

FIG. 1(c) is a flow diagram illustrating in detail a method comprising a step of determining if access to an account is permitted in accordance with the method illustrated in FIG. 1;

FIG. 1(d) illustrates various flow diagrams of methods comprising a variety of methods of utilizing in accordance with the method illustrated in FIG. 1;

FIG. 2(a) is a schematic diagram of a system of the present invention.

FIG. 2(b) illustrates the flow of financial transactions into predefined transaction categories; and

FIG. 2(c) illustrates an example of a monthly financial account statement in accordance with the invention with three example transaction categories defined.

### DETAILED DESCRIPTION OF THE INVENTION

The invention comprises one or more methods and apparatus for facilitating monetary and commercial transactions. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the invention comprises one or more methods and apparatus for facilitating transactions, such as monetary funds transfers and purchases, and especially those occurring at least partially electronically. The invention also comprises methods and apparatus for facilitating commercial transactions, such as the purchase of goods and services.

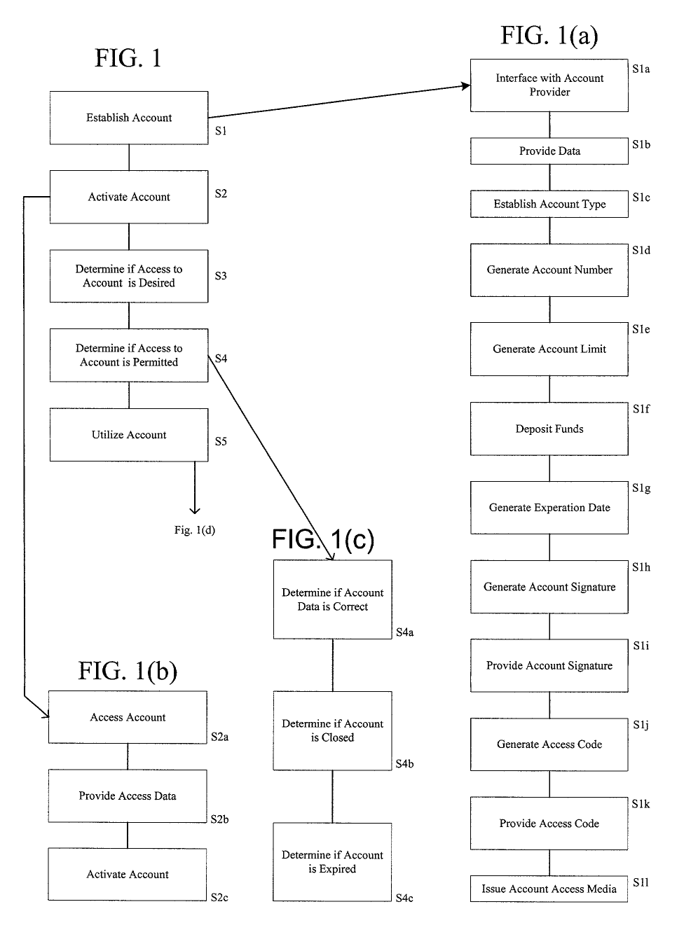

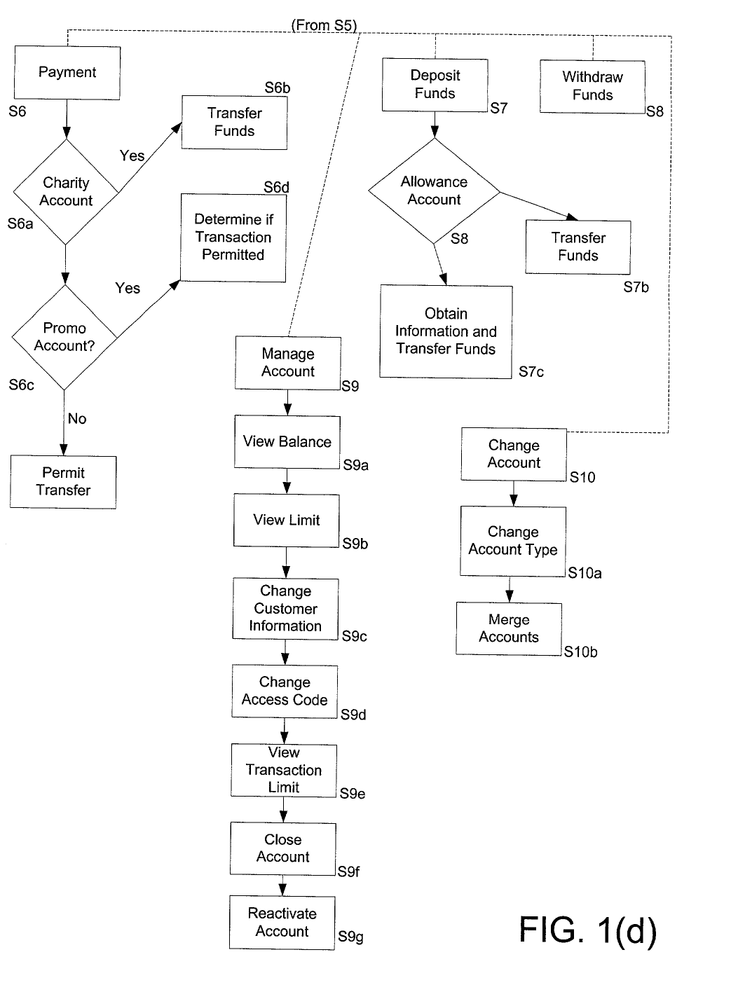

Referring to FIG. 1, one or more embodiments of a method of the invention will be described. First, in a step S11, an account is established. The account may be established by a party for use by themselves or for use by others. As used herein, the person who establishes the account is generally referred to as a customer, regardless of whether that person is establishing the account for themselves or another party or user.

The account is established by an account provider. The account provider may be a retailer, bank or other entity. As provided below, regardless of whether the account is referred to as a financial, bank, debit, monetary or other named account, the account has certain characteristics that define it.

Referring to FIG. 1(a) there will be described one or more methods for establishing an account. In a first step S1a, a customer interfaces with an account provider. This step may comprise the customer accessing a website belonging to the account provider, calling an account provider customer representative, or accessing one or more other means now known or later developed by which the customer may provide information to the account provider.

In a step S1b, the customer provides data to the account provider. This data is used to set up the account. The particular data which is required may vary by provider. In one or more embodiments, the data may include the customer's name and/or the name(s) of the parties which are to be permitted to access the account, address, telephone number, social security number, birth date, mother's maiden name and/or other information. In the event the customer is a business, the information may comprise the business name, address, telephone number, taxpayer identification number and/or similar information.

The particular manner by which this information is transmitted to the account provider may depend upon the interface the customer is using. For example, the data may be input into a graphical user interface associated with the account provider's website and then sent to the account provider's computer, such as over the Internet. The data may be provided orally over the phone by the customer to the account provider.

In a step S1c, an account type is established. In one or more embodiments, the account type may comprise one or more of the following: customer debit, charity debit, promotional, or allowance account.

A customer debit account is preferably of the type where funds belonging to the customer are assigned or credited to the account, and payments, transfers and the like are associated with debits of these funds from the customer's account. This is opposite to a credit type account where those funds which are debited belong to the account provider or other creditor with the requirement that the customer repay the account provider with their funds at a date after a particular transaction. In general, the customer debit account permits a customer to make and pay for purchases, obtain funds (such as currency), and transfer funds into and out of the account.

A charity debit account is preferably of the type where the customer may only transfer funds from the account to an authorized charity or similar entity, with no other debits permitted (except return of the funds to the customer or transfer of funds to another account belonging to another account at the specific instruction of the customer). Generally, the customer will provide the account provider specific information about the charity to which funds are to be transferred. The customer may arrange the account such that funds are debited and transferred to the charity at one or more predetermined times and for one or more predetermined amounts.

A promotional account is preferably of the type where the customer is a promoter arranging an account for use by one or more other parties. For example, the promoter may be a store owner and the parties who may use the account may comprise customers or potential customers of the store. The promotional account is arranged so that the parties or users may access the account in accordance with the terms of a promotion offered by the promoter. A promoter may establish an account having funds permitting a number of parties to pay for a certain dollar amount of goods purchased at their store via the promotional account. For example, a promoter may establish a promotion for a number of parties, such as 1000 existing customers, whereby $10 of each purchase from the promoter over $20 is payed for by the promoter. The $10 payment may be debited from the promotional account at the time each party makes a qualifying purchase to credit the parties' payment of the goods or services.

An allowance account is preferably of the type where funds are arranged to be periodically transferred into the account. Such an account may be extremely useful to parents having children. In accordance with this account arrangement, funds are periodically transferred into the account for subsequent use. The funds may be transferred from another established account, or an account or other source not associated with the account provider. For example, parents may establish a customer account from which funds are periodically transferred, such as every two weeks, into an allowance account which is accessible by one or more of their children. These children may access the allowance account to pay for books and the like. In this manner, the parents may control (and as described below, track) the spending of their children or other parties which have access to the account.

Those of skill in the art will appreciate that the particular type(s) of accounts and their various features or characteristics may be different than those provided above. For example, an account may have one or more features associated with more than one of the account types provided above.

In a step S1d, the account provider generates an account number and associates the account number with the account. The account number may be used by the account provider and customer to identify the account.

In a step S1e, the account provider assigns the account with a maximum funds value or value limit. In general, this value may be selected by the customer. Most often, the maximum value will comprise the amount of an initial deposit into the account by the customer. In one or more embodiments, the account provider may only offer accounts having pre-set limits, such as $50, $100, $250 or $500.

In a step S1f funds are deposited into the account. Preferably, the maximum amount of funds which may be deposited into the account does not exceed the funds maximum value associated with the account.

In one or more embodiments, the customer provides data which permits the account provider to obtain funds electronically. In one or more embodiments, this comprises providing the account provider with a routing number for a checking or savings account at a bank, account and access information for an ATM card linked to an account, or a credit card. In one or more embodiments, a customer may be permitted to deposit funds by mail or similar non or partially non-electronic manner.

In a step S1g, the established account is assigned an expiration date. In one or more embodiments of the invention, this step comprises associating date data with the account. The expiration date may be generated in a wide variety of manners. The expiration date may comprise a date which is determined by adding a fixed period of time to the date on which the account is established or, as described below, the date on which the account is activated. As described below, the account is arranged such that when the actual date reaches the expiration date, the account can not be accessed except by the account provider.

In a step S1h, an account signature is generated and associated with the account. The signature comprises a unique code or other element for establishing entitlement to access the account. In one or more embodiments, the account provider generates the code based on one or more elements of data associated with the account, such as customer provided data, the initial funds deposit amount, the account number, the account expiration date and/or one or more other elements. In one or more embodiments, the account signature is generated from, or includes, an access code or personal identification number (PIN) data assigned to or selected by the customer as described below. In one or more embodiments, the data used to generate the signature may be input into an encryptor to generate an output which comprises the account signature. The account signature may be generated randomly as well. Preferably, whatever means is used to generate the signature, each signature is unique for a particular account.

In a step S1i, the account signature is provided to the customer. In one or more embodiments, the account signature is mailed to the customer, told over the phone by a customer representative of the account provider to the customer, or is transmitted electronically to the customer. As described below, in the event the customer is provided with an account access media, then the account signature may be provided on the account media. The account signature may be printed on, embossed in, or encoded on the account media or an element associated therewith.

In a step S1j, an account access code is generated and associated with the account. In one or more embodiments, the account provider generates the access code. In other embodiments, the customer generates the code and provides it to the account provider. The access code may comprise a personal identification number or “PIN” comprising one or more letters and/or numbers.

In a step S1k, the access code is provided to the customer. In the case where the customer selects the access code, this step is completed at the same time as step S1h. When the account provider generates the code, the code may be mailed, electronically transmitted or spoken to the customer.

In a step S1l, in one or more embodiments, the customer is provided with an account access media. The access media may comprise a card, check, ticket, chip or a wide variety of other items. In one or more embodiments, the account signature is associated with the access media. When the access media comprises a card, check or the like, the account signature and/or account may be printed or encoded thereon. The account signature may be provided in one or two-dimensional bar code form or be encoded in a magnetic stripe or a chip or other data storage element associated with the media.

The account signature and/or access code may comprise a physical characteristic of the customer. For example, the access code may comprise a fingerprint or the customer's retinal features. In general, the account number, signature and access code are for use in identifying the particular account and ensuring that only those parties with authority to access an account can do so. A variety of other methods and devices may be used for these purposes.

A variety of other steps and may be associated with the establishment of an account for the customer, and the steps described above need not be completed in the order in which they were described.

Referring again to FIG. 1, in a step S2, an account which the customer wishes to access is activated. Normally, this step will be in response to a customer wishing to access a newly established account.

Referring to FIG. 1(a), there is illustrated one embodiment of a method of activating an account in the event the account has not been activated. In a first step S2a, the customer accesses the account. In one or more embodiments, this step comprises a customer contacting the account provider, such as via a website of the account provider or by telephone with a customer service representative.

In a second step S2b, the customer provides their account number, signature and, in one or more embodiments, the access code. This account identification and access data may be provided by a customer telling an account representative the information, typing the information into a data input accepting element of a graphical user interface of a website, or otherwise transmitting such to the account provider. In one embodiment, the account number and signature may be scanned off of an account media provided the customer, such as with a magnetic stripe or bar code reader.

In a step S2c, the account provider activates the account. In one or more embodiments, this step comprises associating data with the account which indicates that the customer and/or other designated and/or appropriate parties may utilize and access the account.

The account activation may be accomplished in a wide variety of other manners. For example, in one embodiment, a customer may activate an account by simply calling a phone number of the account provider or entering the appropriate data into the account provider's website. In this arrangement, it is not necessary for the customer to access the account or provide all of the account information which may be necessary for the customer to use the account.

In one embodiment, an account may be activated for use by a customer at the time it is established. In such an arrangement, any access media associated therewith may be separately activated. For example, the account may be activated when established, allowing a customer to make deposits, funds transfers or the like through an account provider representative or website. However, the customer may not be permitted to utilize an account media (such as for purchases or cash withdraws) until the customer activates the account as to the media. The customer may activate an access card by calling a representative of the account provider after the card is received or other means.

Referring again to FIG. 1, in a step S3 it is determined if a customer wishes to access an account, as by a customer's attempted use of the account. This step may be remote in time from step S2, or at the same time. For example, a customer may activate an account shortly after establishing it, but not access the account for several days or weeks thereafter. A customer may also wish to activate an account and utilize it at the same time, such as when the customer wishes to pay for a purchase at a store.

In one or more embodiments, this step comprises determining if a customer is accessing a bank, automated teller, customer service representative, account provider website, remote payment station or the like. In order to determine if the customer is attempting to access an account, particular account information and associated access data is required. This data may be provided to the account provider or other account access controlling entity in a number of manners. In one or more embodiments, the account information may be directly provided by the customer, as through data input into a website or spoken to an account representative, or by reading the information from the access media.

The customer may wish to access the account for a number of reasons. For example, in the event a customer wishes to complete a purchase from a vendor, such as on-line or at a store, the customer may seek to access the account to pay for the purchase. The customer may seek access to the account to obtain funds from an automated teller machine.

In one or more embodiments, data must be provided to the account provider to establish the entitlement of the customer to access the designated account. This information may comprise the account signature and/or access code. Again, the particular means and/or method by which this information is provided may vary. In an embodiment where a customer is seeking to access an account using an access media, the account signature may be read or scanned from the card, and the access code may be provided by the customer, such as through a keypad. The customer may also provide such information through a variety of data input devices, such as a computer or customer station at a store, or provide the information directly to an account representative.

When a customer wishes to access an account, in a step S4 it is determined if the access to the account is permitted. In one or more embodiments, and referring to FIG. 1(c), this step includes a step S4a of determining if the provided account access information is correct and complete. In one or more embodiments, this step comprises comparing the provided account identification and/or access information to that associated with the account which the customer is seeking to access. If the required information has not been provided or is not correct, access to the account is denied. The customer may then be directed to contact the account provider and/or attempt to re-enter the required data in case there was an error in providing or transmitting it to the provider.

If the requisite access information is provided, then in a step S4b, it is determined if the account is closed. If the account has been closed, then access to the account is denied. The account may be closed at the request of the customer, upon violation of account terms and conditions or for a wide variety of other criteria or reasons.

If the account is not closed, then in a step S4c, it is determined if the account is expired. The account may be determined to be expired if a current date is the same as or time-wise later than the expiration date assigned to the account. If the account is expired, the customer is not permitted to access the account directly. Preferably, in that situation, the customer may access the account only through the account provider. The customer may contact the account provider and arrange for the removal of any funds remaining in the account. Alternatively, the customer may be permitted to re-activate the account with a new expiration date.

If in step S4 it is determined that access is permitted to the account, then in step S5, the customer is permitted to utilize the account. As described below, a variety of transactions, interactions with and manipulations to the account are permitted.

Referring to FIG. 1(d), in one or more embodiments, in a step S6, a customer is permitted to utilize the account to make a payment to a third party. A variety of methods may be implemented to effectuate this step. In one or more embodiments, in a step S6a, it is determined if the account is a charity account. If so, in a step S6b, finds are transferred from the charity account to a selected charity.

In one or more embodiments, when a charity account is established, the account provider designates the account a charity account. At that time, a customer may designate one or more charities to which funds placed in the account are to be distributed to. These funds may be distributed in accordance with the specific instruction of the customer at a later date, or at a predetermined time or in accordance with a predetermine schedule. The amount of the funds to be distributed may be designated by the customer as well. In one or more other embodiments, the customer may designate the charity(ies) to which funds are to be distributed after the account has been established.

In one or more embodiments, the funds which are distributed to the charity are transferred electronically from the account by the account provider to an account belonging to the charity or an intermediate escrow account or the like from which the charity may obtain payment. In other embodiments, the funds may be mailed or transmitted in other manners.

If the account is not a charity account, then it is determined in a step S6c if the account is a promotional account. If the account is a promotional account, then in a step S6c, the account may be used to purchase or pay for goods from specific parties. Preferably, the account provider must verify that the purchase is being made from one of the authorized parties. Normally, when the purchase is being made, the vendor will transmit vendor identification information along with the customer's account information. The account provider can verify the vendor from the provided vendor information.

If in step S6c it is determined that the account is not a promotional account, then it is determined that the account is a customer or allowance account which may be used as the source of payment for a transaction with, in general, any party. In step S6e, the purchase or other transaction is then facilitated by debiting the account.

It will be appreciated that a variety of steps other than those described may be associated with the payment of a purchase from the account. For example, in one step, the account provider must generally verify that sufficient funds exist in the account to permit the transaction. If sufficient funds do not exist, then the transaction may not be permitted. Alternatively, as described below, the account may be provided with a “credit” or “overdraft” feature which would still permit the customer to access the account.

As part of the transaction, the particular vendor may send information which facilitates the transfer of funds from the customer's account to the vendor's account by the account provider. For example, this information may comprise a vendor identification or account number.

As provided above, the method and apparatus by which the customer accesses the account to facilitate a purchase may vary. For example, if the customer is purchasing goods at a store, the customer may swipe their access media through a card reader and enter their access code. If the purchase is through a web-site or similar on-line access, the data may be input into a graphical user interface of the site.

In accordance with one or more embodiments of the invention, the payment for purchase may be arranged as an automated debit from the account. For example, a customer may arrange for payments to be made from the account on a periodic basis, such as in response to monthly amounts due a party (such as for a car payment or the like). In such event, the customer may provide the necessary debit information to the account provider.

In one or more embodiments, a purchase may be made in the form of an automatic funds transfer. For example, a customer may arrange with a particular vendor an arrangement where payment for the goods or services is made automatically. The customer provides the vendor with the account data which is then used by the vendor at one or more times subsequent thereto to affect payment. As an example, a customer may provide account data to their electric company. The electric company may then receive payment for the electricity supplied to the customer each month directly from the account through the account provider without intervention by or acts required by the customer. In this embodiment, the step of the customer accessing the account, step S3, generally comprises the customer providing the account data to the vendor or other party and then the vendor accessing the account as agent of the customer.

As one aspect of utilizing the account, as illustrated in FIG. 1(d), in a step S7, in one or more embodiments a customer may deposit funds into the account. A variety of methods may be implemented to effectuate this step. In one or more embodiments, this step includes a step S7a of determining if the account is an allowance type account. If so, then in a step S7b, funds are periodically transferred into the account. If the account is an allowance account, a customer will have provided the account provider with a source of funds from which a transfer into the account is to be made. The source of funds may be a customer's credit card, a bank account, or another account in accordance with the present invention. The customer will also have provided the account provider with specific instructions as to when funds are to be deposited, in what amount and the like.

If the account is not an allowance type account, then in a step S7c, the customer must specifically arrange for the particular transfer of funds with the account provider. For example, the customer may access a web-site or customer representative and provide source funds data. This data may comprise credit card information, bank account and routing information or the like. The customer may also arrange for funds transfer between accounts at a bank or similar provided customer station, phone controlled system or the like.

As one aspect of utilizing the account, as illustrated in FIG. 1(d), in a step S8, in one or more embodiments a customer may withdraw funds from the account. A variety of methods may be implemented to effectuate this step. In one or more embodiments, the funds withdrawal may comprise the issuance of currency such as U.S. or other dollars, or other media. In one or more other embodiments, the withdrawal may comprise the transfer of funds to another entity or account.

In general, when the customer desires to obtain currency, the customer travels to an automated teller machine (ATM), bank or similar currency dispensing location. In such event, the step of providing the requisite account data (see step S3) may comprise swiping an account media and inputting an access code. In the event the customer does not have an access media, the customer may provide the requisite data directly to a teller or other bank personnel for input into a system.

If the customer desires to withdraw funds and have the funds transferred into another account, the customer may be permitted to do such over the phone, via the account provider's web site, or at a bank or other location. In this regard, the number of locations at which a customer may effectuate the transfer is not constrained to locations where currency can be dispensed.

If the customer requests funds, and if such funds exist in the account, the customer is provided with funds. This step may include the step of transmitting the fund request to the account provider and the account provider comparing the amount of funds requested versus the total amount of funds in the account. If the funds exist, then the account provider may send a signal or other indication that it is permissible to dispense the funds.

In one or more embodiments, the customer is permitted to request currency or a transfer. If currency is requested, then currency is dispensed. If a transfer is requested, then the funds may be transmitted electronically to a new account. In the event the funds are to be transferred to another account, the customer provides the necessary information, such as the receiving account number and/or routing number and/or receiving party information.

As one aspect of utilizing the account, as illustrated in FIG. 1(d), in a step S9, in one or more embodiments a customer may obtain account information and manage their account. A variety of methods and devices may be utilized to effectuate this step. For example, a customer may call an automated telephonic information system, call a customer service representative or access a web site belonging to the account provider. In one or more embodiments, certain information and transactions may be permitted through an automated teller machine or similar remote access site.

In one embodiment, this step may include one or more of the following steps. In a step S9a, a customer may be permitted to obtain their account balance. The account balance may be provided on a viewing screen or printed on paper.

In one or more embodiments, in a step S9b, a customer may obtain the account limit for their account. The limit value may be displayed to the customer if the customer is located at a display, or may be printed onto a media, such as paper, and dispensed or mailed to the customer. If the customer is utilizing a phone system, the information may be transmitted over the phone.

In one or more embodiments, in a step S9c, a customer may change information associated with their account. This information may comprise their name, address, telephone number, the name(s) of parties permitted to access the account and the like.

In a step S9d, a customer may change their access code or similar access information. For example, in one embodiment, the account provider may assign the customer the access code when the account is established. In accordance with this step, the customer may change this access code to a code of their selection.

In a step S9e, a customer may obtain information regarding transactions associated with the account. This information may include information regarding fund deposits, withdraws and other transactions. In one or more embodiments, the customer may obtain information regarding an amount paid or transferred out of the account, the date of the transfer and the party to whom the amount was paid or transferred. The customer may obtain information regarding an amount deposited or transferred into the account, the date of the transfer and the origin of the funds.

In a step S9f, a customer may close the account. When closing the account, the customer may indicate to the account provider the location to which any funds remaining in the account are to be transferred.

In a step S9g, a customer may re-activate an account in order to change its expiration date. For example, before an account expires, a customer wishing to utilize the account for a longer period of time may elect to re-set the expiration date for the account. In one or more embodiments, the date is automatically set by the account provider, such as by adding a period of time to the current expiration date or the current date. In one or more other embodiments, the customer may select a new expiration date in the future.

As one aspect of utilizing the account, as illustrated in FIG. 1(c), in a step S10, in one or more embodiments a customer may change the status of the account. A variety of methods may be implemented to effectuate this step. In a step S10a, a customer may change the account type, such as from a customer account to a charity or other account, or vice versa. In a step S10b, a customer may merge one account with another account. For example, a customer having two accounts may wish to merge the accounts into a single account. A customer having one account may establish another and then merge or eliminate the first account in favor of the second.

Several examples of account merging are provided below:

John Doe's Debit Accounts

| Account Type | Balance | Status |
|---|---|---|
| $250 Debit Account | $100 Remaining | Active until 1/1/01 |
| $150 Debit Account | $50 Remaining | Active until 4/1/01 |
| /// | | |
| /// | | |
| /// | | |

After merging accounts into a new account:

John Doe's Debit Accounts

| Account Type | Balance | Status |
|---|---|---|
| $250 Debit Account | $0 Remaining | Closed |
| $150 Debit Account | $0 Remaining | Closed |
| $150 Debit Account | $150 Remaining | Active until 6/1/01 |

Alternatively, the owner of the accounts may wish to transfer the $100.00 remaining from the $250 account into the $150 account with $50.00 remaining. This would close the $250 debit account and establish a new balance of $150 in the $150 debit account. An example of this transaction is as follows:

John Doe's Debit Accounts

| Account Type | Balance | Status |
|---|---|---|
| $250 Debit Account | $100 Remaining | Active until 1/1/01 |
| $150 Debit Account | $50 Remaining | Active until 4/1/01 |

After transferring the remaining amount into the $150 account:

John Doe's Debit Accounts

| Account Type | Balance | Status |
|---|---|---|
| $250 Debit Account | $0 Remaining | Closed |
| $150 Debit Account | $150 Remaining | Active until 4/1/01 |

A customer may also be permitted to close the account. If the account is empty, the account is simply closed by the account provider so that further access to the account by the customer is prevented. In the event funds exist in the account, the customer may be provided with the option of transferring the funds to another location or account, or obtain the funds from the account provider by mail.

In accordance with one or more embodiments of the invention, the account provider may provide a credit line or “overdraft” protection for the account. This option may be provided to the customer for free or upon payment of specific service charges. In accordance with this embodiment, in the event a customer wishes to withdraw funds from the account (whether to obtain currency, transfer to another account or payment for goods/services) in an amount greater than that which exists in the account, the account provider may supply the funds to the customer.

In one or more embodiments, the account provider may charge the customer a specific fee for utilizing the credit line, such as a per usage fee, interest or the like. In one or more embodiments, after a particular transaction which exceeds the amount of funds in the account, the account is frozen until sufficient funds are placed in the account or provided to the account provider to cover the funds deficiency.

One or more embodiments of the invention comprise apparatus for use in performing the above-described methods. As stated above, this apparatus may include an access media, such as a card, check, chip or the like. The apparatus may also include a wide variety of devices for interacting with the account provider and/or account. These devices may include some existing devices, such as existing bank teller machines, card reading devices, and data receiving and transmitting devices.

In one or more embodiments, a customer is permitted to establish and interact with their account via a website or similar on-line access. The website may include a graphical user interface designed to provide information to the customer and prompt and accept that information. The website may have multiple levels or pages. For example, the website may have a home page or “log-in” page which prompts a customer to either identify that they are a new customer and wish to establish or activate an account or identify themselves as an existing customer and have them provide the requisite account information.

If the customer is a new customer, the customer may be sent to a webpage at which information is provided to the customer about the various accounts which may be established. This or other pages may include prompts for providing the data necessary to establish an account.

If the customer is an existing customer and provides the necessary information to access the account (as in Step S3-S5 set forth above), then the customer may be presented with a menu page. At this page the customer may be selected with a menu of items from which to select. These items may be similar to those of steps S7-110. For example, a customer may be provided with a “manage account” item. Upon selecting this item, the customer may be presented with a number of sub-menu items. These items may comprise those items identified in steps S9a-f.

In one or more embodiments, a webpage may display account information for more than one account belonging to a customer. A variety of means may then be presented to the customer for use in manipulating these accounts. For example, a customer may then be permitted to “drop and drag” funds or the like from one account to another.

In one or more embodiments, the account provider has one or more devices adapted to store account information and receive and transmit account data, data representing funds transfers and the like. The account provider may have a system which includes a data storage device, a data input device and a data transmitting device. The data storage device may comprise one or more hard drives or similar elements used to store account data. Modems, servers or similar devices may be used to transmit and receive data. This system may include one or more processors arranged to process data.

The devices used to implement the present invention may be incorporated into existing systems facilitating monetary and commercial transactions. For example, the access media associated with an account in accordance with the present invention may be utilized with current card-reading devices.

In accordance with one or more embodiments of the invention, an account provider may issue accounts associated with access media which are available for purchase by customers. For example, an account provider may associate an account with an access media. The access media may have associated therewith an expiration date, account data and a maximum value. A customer may “purchase” the account and associated access media at a retail location. When the account provider is a bank, the bank may place access media on sale at retail locations such as grocery and retail stores.

A customer purchases the account and card by paying the retailer (who in turn pays the account provider). In one or more embodiments, the customer may thereafter access the account by activating the account. This may comprise calling the account provider after purchase. At that time, the account provider may provide the customer with an access code for use in using the access card. The access code could be provided on the card, but this arrangement has added security in that the account provider can ensure that the account is only accessed once it has been paid for.

In this embodiment, a customer may conveniently obtain a “pre-paid” account for themselves or for another party. The account may be used in similar fashion to a credit or ATM card, permitting purchases from any vendor and permitting access to cash from any of a variety of cash-dispensing locations.

It will be noted that in this embodiment, the step of establishing the account is generally accomplished by the account provider without input from the customer. In one or more embodiments, after purchasing or obtaining the access card, a customer may be required or permitted to provide additional information in order to access the account.

It is preferred that the access card indicate the expiration date of the access media. If the access media and associated account is expired, the purchase is not permitted. If the access media is about to expire, the customer may purchase it and, if the customer wishes to extend the expiration date, contact the account provider after purchase to do so. In one or more embodiments, the expiration data may not be printed on the access media, but when it is purchased scanned, read or the like by the vendor to ensure that it is still valid. When a purchase of an access media is made, the expiration data may then be reset a predetermine time from the purchase, with this information scanned onto the card or otherwise associated with the account.

In the above-described arrangement, each access media, once paid for, generally has the same characteristics as cash. A customer may pay for goods using the purchased access media. A customer may deposit the funds associated with the access media into another account, or transfer it to another party.

The present invention has numerous benefits and advantages. First, an account of the present invention is configured to permit minors to make financial transactions. In accordance with the invention, a debit account is established by or for the minor. Because of the existence of the funds in the account, a minor may complete a transaction without concern to the account provider/financial institution that the minor will pay for goods.

In one or more embodiments, this arrangement permits a customer to “buy” an account for use by another person in a fixed amount. In this manner, the account may be used as a gift. This arrangement has the advantage that the recipient of the account can utilize the finds associated with the account to make a purchase or pay for goods/services from essentially any location. The recipient may purchase goods on-line or at a store. The recipient is not limited to a particular store or mall.

The customer may also utilize one or more of the accounts in similar fashion to travelers checks. Because the funds associated with the accounts are different, a loss such as by theft of a single access media does not affect the remaining funds. For added security, each access media may have a different access code.

Parents and others may arrange an account for their children. The children are not permitted to spend more money than their parents provide, because of the arrangement of the account. On the other hand, the parents can provide their children with a convenient means for paying for items even though they may be located a great distance apart. The parents may also access the account to track purchases and other transactions by their children. The parents may also arrange the account as an “allowance” account, where funds are placed into their children's account at predetermined intervals without specific action by the parents or children at the time of each deposit.

The methods and accounts of the present invention has several safety features. Because the account expires after a predetermined time, the risk that a thief may find and be able to use a lost access card is reduced. The account is associated with a unique account signature which is generated from data which is difficult to obtain.

The methods and accounts permit a wide range of transactions, including a number of very specific transactions which are not presently facilitated. For example, a vendor may establish promotional accounts for current and potential customers. One advantage of a promotional account is that a large company may establish accounts which customers can use at one or more of their stores located in different areas. For example, a retailer having outlet in Los Angeles and New York may issue cards associated with accounts for use by customer at either location. This arrangement is also advantageous for franchisees: the franchiser may sponsor a promotion for their franchisees whereby the discount or amounts provided to the customers are paid for by the franchiser.

A promotional account may also be a prize or award. A vendor may award an account to one or more customer who win a contest or drawing or the like. A vendor may also arrange the promotional account with an expiration date requiring the customer to utilize the account within a predetermined time.

A customer may establish a charity account for themselves, or a charity may establish an account for a customer. For example, a charity may seek donations from customers in the form of deposits into a charity account established by the charity for the customer.

In one or more embodiments, a customer or other user of a promotional account may be prevented from any account activities except use of the account to facilitate a purchase. The customer or user to whom the account is issued may be prevented from obtaining funds from the account (such as cash) or viewing data associated with the account such as the remaining balance or the like. A customer may also be prevented from merging the account or adding funds to the account. On the other hand, a vendor may be permitted to track all purchases and other uses of promotional accounts. In this manner, the vendor can obtain important data regarding the customer, including their spending habits, spending locations and similar information.

A business may use the account for business to business transactions. For example, a business may set up a master account and a number of sub or allowance accounts. The business may use the accounts to pay suppliers of goods and services. The master account may comprise a main account for the business and each allowance account an account relating to a particular vendor or project. Commensurate with billing or an accounting period, the business may have arranged an automatic transfer of funds from the master account to one or more of the allowance accounts, and from one or more of the allowance accounts to each particular supplier for their bill.

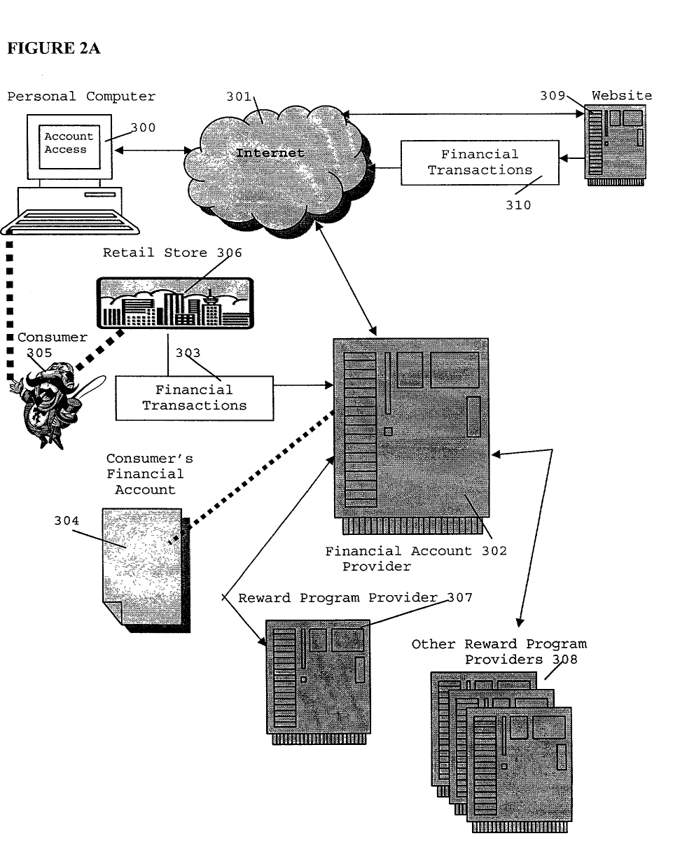

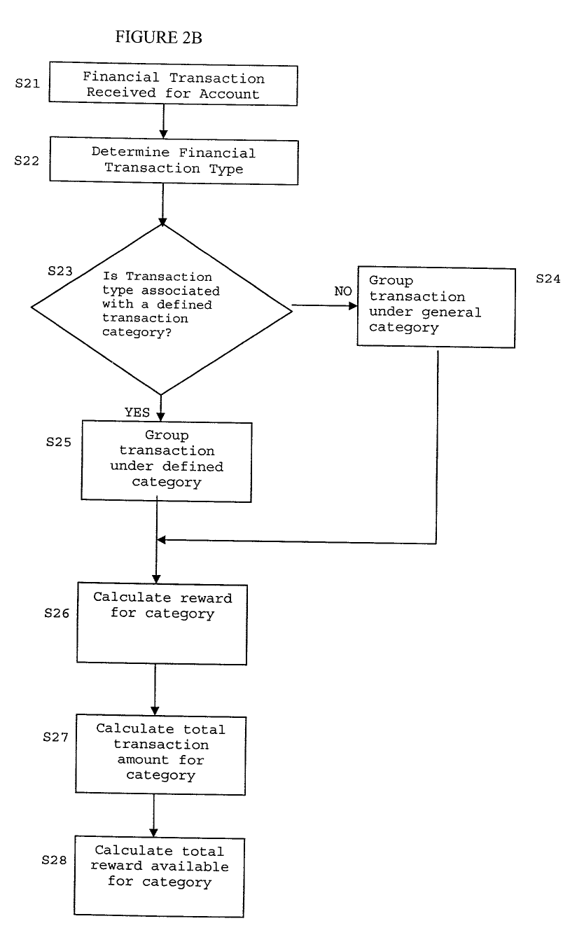

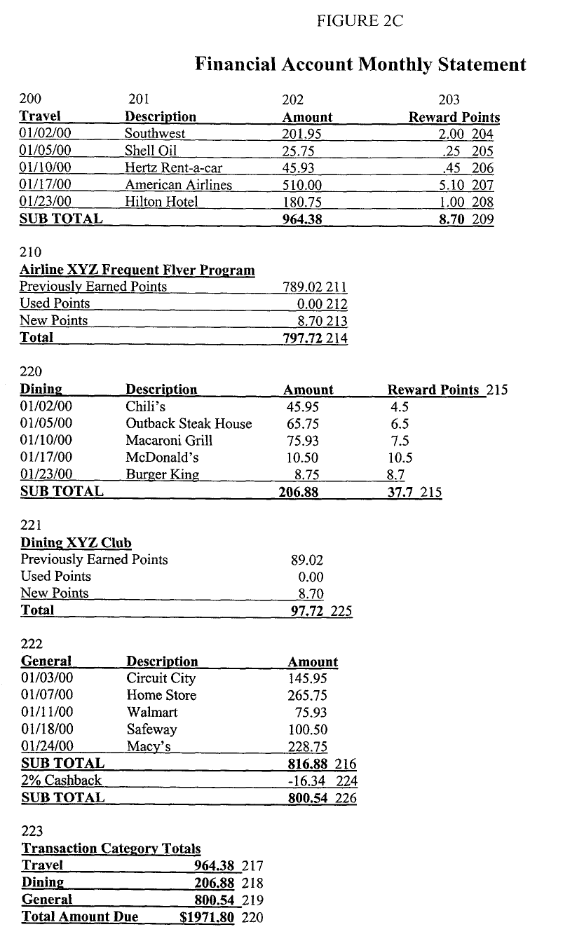

Another aspect of the invention will be described in FIG. 2(a)-(c). This aspect of the invention comprises one or more methods and systems for associating a plurality of reward programs with a single financial account. Table I below illustrates one embodiment of an association between specific transactions grouped into transaction categories, which categories are then associated with a specific reward program. In a preferred embodiment, the financial account includes transaction grouping categories defined by the account provider whereby each of the transaction categories is associated with a single reward program.

TABLE I

| Transaction Categories | Reward Programs |
|---|---|
| Category A | Program 1 |
| Category B | Program 2 |
| . . . | . . . |

In alternative embodiments, a specific reward program may be applied to more than a single transaction category. In other alternative embodiments, a plurality of reward programs may be applied to a specific transaction category.

FIG. 2(a) is a schematic diagram of a system configuration where transactions are made by the consumer, tracked by the financial account provider and accessed by the consumer over the Internet.

Financial transactions 303 result from the use of the financial account 304 (such as one or more of the accounts described in detail above) by a consumer 305. The transaction may be facilitated by the use of a credit card, debit card or smart card to make purchases at a retail store 306. The financial transactions 303 occur as the consumer 305 uses the consumer's financial account 304 to make purchases at the retail store 306. Information regarding the financial transactions 303 is transmitted to a financial account provider 302 and are placed into the financial account 304 belonging or assigned to the consumer 305.

The consumer 305 may then access their financial account 304 over the Internet 301 from a personal computer 300. The financial account 304 access enables the consumer 305 to review the status of their financial account 304 and to manage a reward portion of their financial account 304. Such management of the reward programs associated with the consumer's financial account 304, by the consumer 305, includes the ability to redeem reward points for available rewards provided by the financial account provider 302 or reward program provider 307.

In other preferred embodiments, the consumer 305 may wish to use their financial account 304 for purchases or other transactions over the Internet 301 at a website 309. The financial transactions 310 are then transmitted over the Internet 301 to the financial account provider 302 and into the financial account 304.

The financial account provider 302 may have business relationships with a plurality of other reward program providers 308. In preferred embodiments a reward program provider 307 may exist for each of the reward programs associated with the consumer's financial account 304. In other preferred embodiments, the financial account provider 302 may provide the reward program(s). In other preferred embodiments, there may be a combination of reward programs provided by both the financial account provider 302, the reward program provider 307 and other reward program providers 308.

FIG. 2(b) illustrates the flow of financial transactions into defined transaction categories in accordance with an embodiment of the invention. Referring to FIG. 2a, in a step S21, a financial transaction, resulting from the use of the financial account, is received by financial account provider for an individual's financial account.

In a step S22, the financial transaction is evaluated to determine the transaction type. The transaction type is preferably a form of identification which is used to associate or group individual transactions with or to financial transaction categories. For example, if the financial account were used to purchase an airline ticketed from Southwest Airlines, the resulting financial transaction of $201.00 could be assigned a “travel” transaction type. All travel transaction types would then be grouped under the “travel” financial transaction category. In a preferred embodiment, the financial account provider may define the financial transaction types and financial transaction categories. In alternative embodiments, the consumer may be enabled by the financial account provider to define their own financial transaction types and financial transaction categories. In general, particular characteristics or criteria may be utilized to identify the type of financial transaction. For example, the characteristics may include the name of the provider of the good or service or descriptions of particular goods and services.

In a step S23 a decision is made regarding which defined transaction category the financial transaction should be placed therein. This decision is based upon the defined associations between financial transaction types and financial transaction categories. The association is tested for each financial transaction received which is associated with a particular financial account.

In a step S24, if there is no defined category for the type of transaction being processed by the financial account provider the financial transaction may be associated with a general category. For example, if a transaction received has no transaction type defined for it and no association can be made between the transaction received and the defined transaction categories, the financial transaction may then be considered a general or “unclassified” transaction type and grouped in a general transaction category.

When the received transaction is associated with a defined transaction type, step S25 results. In a step S25, a specific transaction category has been identified for the type of financial transaction received and is grouped together with other financial transactions of the same transaction type into the associated transaction category.

In a step S26, a reward is calculated for the transaction received based upon the defined rules of the reward program associated with the transaction category with which the financial transaction is grouped.

In a step S27, the financial category total with which the financial transaction was grouped, is updated to reflect a new value based upon the financial transaction received. The update involves adding the received financial transaction with the associated financial transaction category to determine the new total transaction amount for the transaction category.

In a step S28, the financial category reward total associated with the particular financial transaction category is updated to reflect a new reward value based upon the financial transaction received. The update involves adding the received financial transaction reward value with the award total existing for the associated financial transaction category before that transaction. The result is a new total transaction reward amount for the transaction category. The total reward may be reward points, cash back, discounts, or other reward programs based upon the total transaction amount of the category and the corresponding rules of the associated reward program. In other embodiments, points, cash back, discounts, and other rewards may be based on the number of transactions whereby the total number of transactions relates to a transaction category.

Table II illustrates an example of a preferred embodiment with defined transaction groupings associated with defined reward programs. Each row of the table illustrates an example of a specific transaction category to reward program association whereby the defined transaction category, for example Dining, is associated with a specific reward program, for example the Diner XYZ Club.

TABLE II

| Transaction Categories | Reward Programs |
|---|---|
| Travel | Airline XYZ Frequent Flyer Program |
| Dining | Diner XYZ Club |
| General | 2% Cash-back over $250 |

In one or more embodiment, categorized financial transaction information is utilized to generate reward and other information. This information may be stored, such as in data files, and in one or more embodiments, may be presented to the customer. FIG. 2(c) is an example of a monthly financial account statement which may be mailed or viewed in electronic form by a customer. In this example monthly statement, three example transaction categories defined. These example transaction categories are Travel 200, Dining 220 and General 222. While this example of the preferred embodiment illustrates the use of three defined transaction categories for clarity, it will be appreciated that the preferred embodiment is not limited to only the three categories. Many other available transaction categories associated with the preferred embodiment are assumed and may be associated with the preferred embodiment of the financial account.

FIG. 2(c) illustrates the Travel 200 transaction category with an example listing of financial transactions of the travel type. The example listing provides a header for the Travel 200 transaction category establishing information columns as follows: Travel 200, Description 201, Amount 202 and Reward Points 203. Example transactions are illustrated in row format with information listed in each of aforementioned information columns. For example, travel transaction 204 occurred on Jan. 2, 2002 with a purchase to Southwest (Description 201) for an of 201.95 (Amount 202), earning 2.00 (Reward Points 203). Travel transaction 205 occurred on Jan. 5, 2000 with a purchase to Shell Oil for 25.75, earning 0.25. Travel transaction 206 occurred on Jan. 10, 2002 with a purchase to Hertz Rent-a-car for 45.93, earning 0.45. Travel transaction 207 occurred on Jan. 17, 2000 with a purchase to American Airlines for 510.00, earning 5.10. Travel transaction 208 occurred on Jan. 23, 2002 with a purchase to Hilton Hotel for 180.75, earning 1.00. The Subtotal Row 209 of the Travel 200 category illustrates Amount 202 of total Travel 200 transactions for an amount of 964.38, earning 8.70 Reward Points 203.

Associated with the Travel 200 transaction category is a Reward Program 210. In one embodiment, this Reward Program 210 is an Airline XYZ Frequent Flyer Program. Each row reflects the status of the Reward Program 210. Row 211 illustrates the total Previously Earned Points of 789.02. Row 212 illustrates Used Points of 0.00 and Row 213 illustrates New Points of 8.70. The Row 213 New Points value of 8.70 is from Reward Points 203 Subtotal Row 209 Travel 200 reward point calculation of 8.70. Row 214 lists a Total Reward Points value for Reward Program 210 associated with the Travel 200 financial transaction category to be 797.73 points.

Financial transaction category Dining 220 lists an example set of financial transactions associated with the Dining 220 transaction category. Subtotal Row 215 of transaction category Dining 220 lists the total amount of financial transactions to be 206.88, earning a total of 37.7 points. Reward Program 221 Dining XYZ Club is associated with financial transaction category Dining 220. Row 225 of Reward Program 221 lists the total amount of reward points of 97.72. The Reward Program 221 associated with the transaction category Dining 220, converts every $1 dollar spent on Dining 220 to Reward Program 221 point value of 0.1 reward points.

Financial transaction category General 222 lists an example set of financial transaction associated with the General 222 transaction category. Subtotal Row 216 of transaction category General 222 lists the total amount of financial transactions to be 816.88, earning a 2% Cashback award illustrated therein Row 224 of 16.34. Row 226 applies the Row 224 2% Cashback award to the General 222 transaction category subtotal Row 216, making the total amount owed illustrated in Subtotal Row 226 to be 800.54.

Transaction Category Totals 223 list the subtotals from each of the transaction categories: Travel 200, Dining 220 and General 222. In Row 217 the transaction category Travel 200 is listed with a subtotal amount of 964.38 from Travel 200 transaction category Subtotal Row 209. In Row 218 the transaction category Dining 220 is listed with a subtotal amount of 206.88 from Dining 220 transaction category Subtotal Row 215. In Row 219 the transaction category General 222 is listed with a subtotal amount of 800.54 from General 222 transaction category Subtotal Row 226. The total amount due Row 220 reflects a balance of 1971.80.

Each of financial transactions result in a reward based upon the rules of the particular reward program. Rules vary from program to program and are defined by the account or reward program provider. The example illustrated in FIG. 2(c), defines XYZ Airline Frequent Flyer Reward Program 210 associated with the transaction category Travel 200. The example Reward Program 210 converts every one $1 dollar spent on Travel 200 type transactions to a 0.01 reward points. The Diner 220 transaction category is associated with the Dining XYZ Club Reward Program 221. In this example, Reward Program 221 converts every one $1 dollar spent on Dining 220 type transactions to 0.10 reward points.

It will be appreciated that the financial transaction and reward information need not be arranged or generated specifically as illustrated in FIG. 2(c). For example, the information need not be arranged in the specific table format including rows. The information could be presented graphically, or otherwise.

After a specific number of points are accumulated in each of the associated Reward Programs 210 or 221, the consumer has various rewards to choose from which may be unique to the Reward Program 210 or 221. For Travel 200 Award Program 210, rewards may consist of free airline flights on specific airlines or free upgrades to first class. For Dining 220 Award Program 221, rewards may consist of free meals, 2-for-1 offers, and other discounts based on the total reward points accumulated. For General 222 transaction category, an example Cashback Reward Program is illustrated on Row 224. In preferred embodiment example, the consumer receives 2% Cashback on General 222 type transactions. In other embodiments, tiered reward programs, fixed dollar discounts, different percentages of cash-back depending upon the amount of the transactions, or credits for merchandise after a certain number of transactions have occurred may be defined as the preferred embodiment Reward Program.

In the preferred embodiment example, the consumer may wish to redeem points associated with their Travel 200 transaction category for a free flight to Timbuktu. The consumer accesses their account over the Internet using their home computer and selects their reward. Upon selection of the trip to Timbuktu, their financial account Reward Program used is updated to reflect the use of the reward points for the flight to Timbuktu.

In yet another alternative embodiment, the consumer may customize their financial account transaction categories with reward program associations they choose. Such embodiments provide the consumer with additional flexibility and incentives targeted towards the consumer's personal spending habits and behavior.

Transaction categories in other preferred embodiments may include financial transactions types associated with specific expenditures for example: clothing, music, grocery, furniture, housing, and vacation rentals. Each of these transaction types becomes a defined category and may be associated with a specific reward program.

In other embodiments, these transaction categories may be broken into more detailed subgroup transaction categories. For example, if grocery were a financial transaction category, it may have subgroups for certain categories of groceries such as meat, dairy, produce, and the like. Each of these subgroups may also have its own reward program, each of which is managed independently from the other groups and subgroups.

In one embodiment, a customer may be permitted to manually categorize or re-categorize a particular financial transaction. For example, if a particular financial transaction is mis-categorized, the customer may be permitted to move or re-assign in to an appropriate category. The financial account provider may impose rules for these activities.

In other alternative embodiments, the consumer may wish to move reward points from one transaction category reward program to another. In such an embodiment, the consumer may wish to convert a certain number of travel reward points to dining reward points in order to qualify for a specific dining reward of interest to the consumer.

While the preferred embodiment and numerous alternative embodiments of the invention have been disclosed and described in detail herein, it may be apparent to those skilled in the art that various changes in form and detail may be made therein without departing from the spirit and scope thereof.

It will be understood that the above described embodiments of apparatus and the methods therefrom are merely illustrative of applications of the principles of this invention and many other embodiments and modifications may be made without departing from the spirit and scope of the invention as defined in the claims.

I claim:

1. A method of facilitating financial and reward transactions in a financial system for use by a consumer, comprising:
(a) providing a plurality of financial transaction categories;
(b) assigning types of financial transactions to said plurality of financial transaction categories;
(c) providing a plurality of reward programs; and
(d) associating a reward program with each financial transaction category.

2. The method in accordance with claim 1 wherein said financial transactions are financial debit transactions or credit transactions resulting from the use of a debit card, a credit card, a smart card, or other financial instrument.

3. The method in accordance with claim 2 wherein said financial transactions are associated with an account assigned to said consumer.

4. The method in accordance with claim 3 including the step of generating reward information for financial transactions assigned to financial transaction categories and associating said reward information with said account.

5. The method in accordance with claim 4 further including the step of accessing said account from a personal computer connected to the Internet.

6. The method in accordance with claim 1 including the step of assigning reward program criteria to said plurality of reward programs and generating reward data from financial transactions associated with said financial transaction categories.

7. The method in accordance with claim 6 further including the step of selecting a reward based upon said reward data in accordance with said reward program criteria and updating the reward data associated with said financial transaction categories.

8. A method of assigning a financial transaction to a financial transaction category for use by a consumer in a rewards program, comprising:
(a) determining a financial transaction type;
(b) determining an appropriate financial transaction category to which said financial transaction is to be assigned;
(c) generating total transaction amount data for each financial transaction category using said information regarding assigned financial transactions; and
(d) calculating a reward based on aggregated financial transaction for said category.

9. A financial account system for use by a customer, said system comprising a means for grouping financial transactions into financial transaction categories based on financial transaction types whereby financial transactions of the same type are grouped into the same transaction category; means for associating at least one transaction category to at least one of a plurality of reward programs; and means for providing a plurality of reward programs to a consumer.

10. The financial account system in accordance with claim 9 including means for a consumer to associate a reward program to a transaction category.

11. The financial account system in accordance with claim 9, including means for defining a financial account having financial debit and credit transactions grouped into one of said financial transaction categories.

12. A method of providing a financial account for use by a consumer engaging in financial transactions associated with said financial account comprising:
(a) defining available financial transaction types for the financial transactions engaged in by said consumer;
(b) associating each financial transaction type to one of a plurality of financial transaction categories; and
(c) selecting one of a plurality of reward programs and associating it at least one reward program to each transaction category.

13. The method in accordance with claim 12 including the step of generating reward points based upon financial transactions assigned to each financial transaction category based upon said associating of said financial transaction types with said categories, and transferring reward points from one or more reward programs associated with a first financial transaction category to one or more reward programs associated with a second financial transaction category.

14. The method in accordance with claim 12 including the step of redeeming an earned reward by a consumer associated with one of a plurality of reward programs associated with one of a plurality of transaction categories within said account.

15. The method in accordance with claim 14 wherein rewards are earned through the accumulation of points generated from financial transactions.

16. The method in accordance with claim 14 wherein rewards are determined based upon a plurality of defined tiers, whereby each tier is reached once a certain level of consumer spending as evidenced by financial transactions has been achieved.

17. The method in accordance with claim 14 wherein rewards are determined based upon a percentage of a consumer spending amount and provided to said consumer a cashback reward.

18. The method in accordance with claim 14 wherein rewards are determined based upon the amount of consumer spending and provided to the consumer as merchandise.
